(19) United States
(12) Patent Application Publication
(10) Pub. No.: US 2011/0296932 A1
(43) Pub. Date: Dec. 8, 2011

(54) APPARATUS AND METHOD FOR SAMPLING UNDERWATER RADIOACTIVE SOLUTION

(75) Inventors: Kuo-Yuan Chang, Taoyuan County (TW); Tsu-Han Cheng, Taoyuan County (TW)

(73) Assignee: Institute of Nuclear Energy Research Atomic Energy Council, Executive Yuan, Taoyuan County (TW)

(21) Appl. No.: 12/842,615

(22) Filed: Jul. 23, 2010

(30) Foreign Application Priority Data
Jun. 8, 2010 (TW) 099118518

(51) Int. Cl. G01N 1/14

(52) U.S. Cl. 73/864.34

(57) ABSTRACT

The present disclosure provides an apparatus and a method for sampling underwater radioactive solution. The apparatus and method are used for sampling underwater radioactive waste stored in the radioactive reservoir of nuclear facilities or in the container of said reservoir, in order to determine the nuclides and the radiation dosage at different depths in the radioactive solution.

### CROSS-REFERENCE TO RELATED APPLICATIONS

This non-provisional application claims priority under 35 U.S.C. §119(a) on Patent Application No(s). 099118518 filed in Taiwan, R.O.C. on Jun. 8, 2010, the entire contents of which are hereby incorporated by reference.

### TECHNICAL FIELD

The present disclosure relates to a sampling apparatus and method, and more particularly, to a sampling apparatus and method for underwater radioactive solution.

### TECHNICAL BACKGROUND

Usually the radioactive waste of a nuclear facility is stored in the radioactive reservoir or in the container of the reservoir. To resist high-dosage radiation of the radioactive waste, the radioactive waste is distributed in reservoirs and/or their containers with water filled in. Due to considerations of nuclear security and protection, it is in need to sample, analyze, and monitor the radioactive solution in the reservoirs and their containers, in order to determine the nuclides and the radiation dosage at different depths in the radioactive solution wherein. Thus a database concerning the radioactive conditions can be built up to facilitate the setup of a standard operating procedure for nuclear facilities.

Conventional sampling techniques for underwater radioactive solution are generally applicable to the shallow part of the reservoirs or their containers, and are not capable to sample the solution in the deep. Besides, radiation dosage would accumulate in human bodies of samplers or operators, who have to work in the radioactive circumstance for a long time. More recently a remote-controlled sampling apparatus for underwater radioactive solution was proposed. However, complex operation and an additional underwater camera are prerequisite for the apparatus.

Accordingly, there remains a need in the art for an apparatus and/or a method for sampling underwater radioactive solution that is more effective, low-cost, easy to process, and radiation-resistant than the presently available.

### TECHNICAL SUMMARY

According to one aspect of the present invention, the embodiment provides a sampling apparatus for underwater radioactive solution, comprising: a main unit; a connecting rod, inserted into the main unit; a connecting ring, connected to one side of the connecting rod; a container unit, connected to the opposite side of the connecting ring; a solution access channel, as a pathway for the radioactive solution to be drawn in or extracted out of the container unit; an air compressor, for changing air pressure in the container unit to draw or extract the radioactive solution in or out of the container unit; a holder, for fixing the air compressor on the main unit; a synchronizing connector, for connecting the connecting rod to the air compressor, so as to synchronize the back-and-forth movement of the connecting rod with the air pressure of the air compressor; a control unit, for controlling the operation of the air compressor and then the sampling operation for the radioactive solution; a flexible pipe, connecting the air compressor to the control unit, so as to provide or release air in the air compressor; and a depth-setting unit, disposed on outer walls of the main unit to set an underwater depth for the sampling apparatus to sample the radioactive solution.

According to another aspect of the present invention, the embodiment provides a sampling method for underwater radioactive solution, comprising: providing a sampling apparatus for underwater radioactive solution; setting an underwater depth for the depth-setting unit; putting the sampling apparatus in the radioactive reservoir of nuclear facilities or in the container of said reservoir at the underwater depth; controlling the operation of the air compressor with the control unit and thus move the connecting rod backward to draw in the solution sample; taking the sampling apparatus out of the radioactive reservoir or the container; and controlling the operation of the air compressor with the control unit and thus move the connecting rod forward to extract the solution sample out.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure.

FIG. 1 is a schematic diagram showing the structure of an apparatus for sampling underwater radioactive solution, according to an embodiment of the invention.

FIG. 2 is a more detailed schematic structure of the container unit in the sampling apparatus.

FIG. 3 is a flowchart of a method for sampling underwater radioactive solution, according to another embodiment of the invention.

### DESCRIPTION OF THE EXEMPLARY EMBODIMENTS

For further understanding and recognizing the fulfilled functions and structural characteristics of the disclosure, several exemplary embodiments cooperating with detailed description are presented as follows.

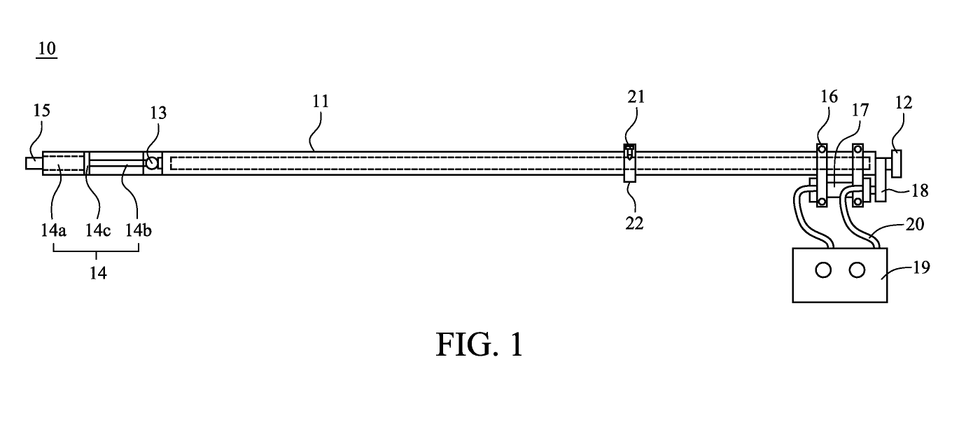

Please refer to FIG. 1, which is a schematic diagram showing the structure of an apparatus for sampling underwater radioactive solution, according to an embodiment of the invention. The apparatus is used for sampling underwater radioactive waste stored in the radioactive reservoir of nuclear facilities or in the container of said reservoir in order to determine the nuclides and the radiation dosage at different depths in the radioactive solution. In FIG. 1, the sampling apparatus 10 comprises a main unit 11, a connecting rod 12, a connecting ring 13, a container unit 14, a solution access channel 15, an air compressor 16, a holder 17, a synchronizing connector 18, a control unit 19, a flexible pipe 20, and a depth-setting unit 21. Generally the main unit 11 has a sufficient length to prevent a sampler or operator from approaching the radioactive waste and its radiation dosage. Also the main unit 11 has a depth scale on itself to facilitate setting the depth to sample the radioactive solution. The connecting rod 12 is inserted into the main unit 11 and is connected to one side of the connecting ring 13. The opposite side of the connecting ring 13 is connected to the container unit 14. The solution access channel 15 is used as a pathway for the radioactive solution to be drawn in or extracted out of the container unit 14. The air compressor 16 is used to change air pressure in the container unit 14, so as to draw in or extract out the radioactive solution sample in the container unit 14. The holder 17 is used to fix the air compressor 16 on the main unit 11. The synchronizing connector 18 is used to connect the connecting rod 12 to the air compressor 16, so as to synchronize the back-and-forth movement of the connecting rod 12 with the air pressure of the air compressor 16. The control unit 19 is used to control the operation of the air compressor 16 and then the sampling operation for the radioactive solution. The flexible pipe 20 is used to connect the air compressor 16 to the control unit 19, so as to provide or release air in the air compressor 16. The depth-setting unit 21 is disposed on outer walls of the main unit 11 and is used to set an underwater depth for the sampling apparatus 10 to sample the radioactive solution. When sampling the radioactive solution in a container of the radioactive reservoir in a nuclear facility, the depth-setting unit 21 further comprises a fixer 22 to fix the main unit 11 on the container and outside the entry of the container.

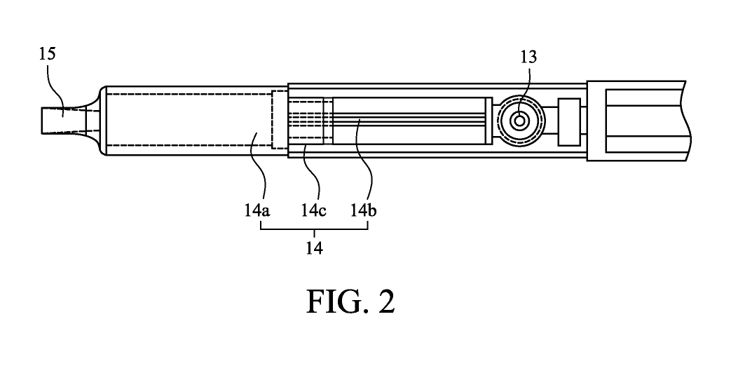

FIG. 2 schematically illustrates a more detail structure of the container unit 14 in the sampling apparatus 10. The container unit 14 further comprises a solution container 14a, an adjusting rod 14b, and a ring buckle 14c. The solution container 14a is used to store the drawn-in solution sample. The adjusting rod 14b is used to adjust the draw-in or extracted-out volume of the sampled solution in the solution container 14a. The ring buckle 14c is used to fix or take apart the solution container 14a on or from the main unit 11. The solution container 14a should be taken apart form the main unit 11 once a sampling process is done, and be replaced with a new one to prevent contamination from residues of the sampled solution.

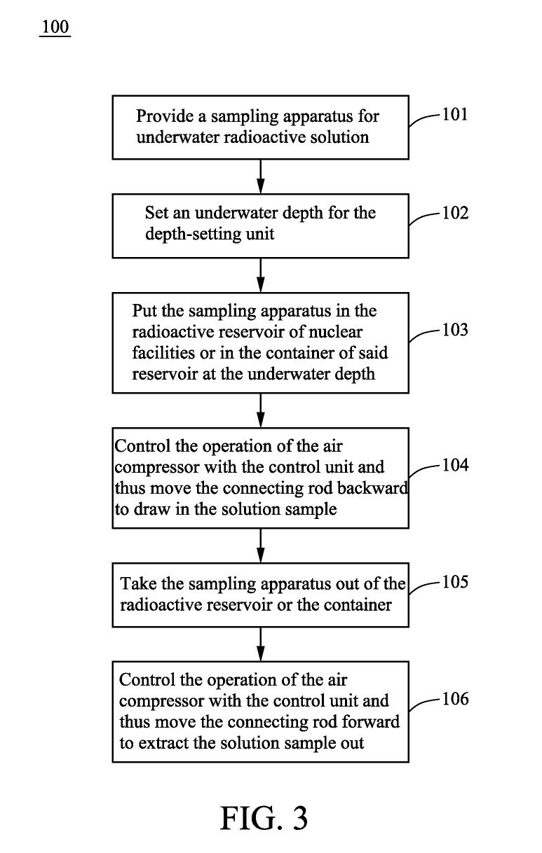

FIG. 3 schematically shows a flowchart of a method for sampling underwater radioactive solution, according to another embodiment of the invention. The sampling method comprises the following steps, wherein the sampling apparatus 10 has been shown in FIG. 1 and the foregoing descriptions. Step 101 is to provide a sampling apparatus 10 for underwater radioactive solution, comprising a main unit 11, a connecting rod 12, a connecting ring 13, a container unit 14, a solution access channel 15, an air compressor 16, a holder 17, a synchronizing connector 18, a control unit 19, a flexible pipe 20, and a depth-setting unit 21, wherein the depth-setting unit 21 is disposed on outer walls of the main unit 11, the control unit 19 is used to control the operation of the air compressor 16, and the synchronizing connector 18 is used to connect the connecting rod 12 to the air compressor 16, so as to synchronize the back-and-forth movement of the connecting rod 12 with the air pressure of the air compressor 16. Step 102 is to set an underwater depth for the depth-setting unit 21. Step 103 is to put the sampling apparatus 10 in the radioactive reservoir of nuclear facilities or in the container of said reservoir at the underwater depth. Step 104 is to control the operation of the air compressor 16 with the control unit 19 and thus move the connecting rod 12 backward to draw in the solution sample. Step 105 is to take the sampling apparatus 10 out of the radioactive reservoir or the container. And finally step 106 is to control the operation of the air compressor 16 with the control unit 19 and thus move the connecting rod 12 forward to extract the solution sample out.

Preferably in the step 101 of the embodiment, the container unit 14 may further comprises a solution container 14a, an adjusting rod 14b, and a ring buckle 14c. The solution container 14a is used to store the drawn-in solution sample. The adjusting rod 14b is used to adjust the draw-in or extracted-out volume of the sampled solution in the solution container 14a. The ring buckle 14c is used to fix or take apart the solution container 14a on or from the main unit 11.

Furthermore in the step 101 of the embodiment, the depth-setting unit 21 further comprises a fixer 22, to fix the main unit 11 on the container and outside the entry of the container of the radioactive reservoir in a nuclear facility to be sampled.

It is noted that the control unit 19 in the sampling apparatus 10 can be a motor, so as to control the operation of the air compressor 16. Meanwhile the synchronizing connector 18 is used to connect the connecting rod 12 with the air compressor 16, so as to synchronize the back-and-forth movement of the connecting rod 12 with the air pressure of the air compressor 16, to control drawing or extracting the radioactive solution sample in or out of the container unit 14.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A sampling apparatus for underwater radioactive solution, comprising:
a main unit;
a connecting rod, inserted into the main unit;
a connecting ring, connected to one side of the connecting rod;
a container unit, connected to the opposite side of the connecting ring;
a solution access channel, as a pathway for the radioactive solution to be drawn in or extracted out of the container unit;
an air compressor, for changing air pressure in the container unit to draw or extract the radioactive solution in or out of the container unit;
a holder, for fixing the air compressor on the main unit;
a synchronizing connector, for connecting the connecting rod to the air compressor, so as to synchronize the back-and-forth movement of the connecting rod with the air pressure of the air compressor;
a control unit, for controlling the operation of the air compressor and then the sampling operation for the radioactive solution;
a flexible pipe, connecting the air compressor to the control unit, so as to provide or release air in the air compressor; and
a depth-setting unit, disposed on outer walls of the main unit to set an underwater depth for the sampling apparatus to sample the radioactive solution.

2. The sampling apparatus of claim 1, wherein the container unit further comprises:
a solution container;
an adjusting rod, for adjusting the draw-in or extracted-out volume of the sampled solution in the solution container; and
a ring buckle, for fixing or taking apart the solution container on or from the main unit.

3. The sampling apparatus of claim 1, when sampling the radioactive solution in a container of the radioactive reservoir in a nuclear facility, the depth-setting unit further comprising a fixer to fix the main unit on the container and outside the entry of the container.

4. A sampling method for underwater radioactive solution, comprising the steps of:
providing a sampling apparatus for underwater radioactive solution, the sampling apparatus comprising a main unit, a connecting rod, a connecting ring, a container unit, a solution access channel, an air compressor, a holder, a synchronizing connector, a control unit, a flexible pipe, and a depth-setting unit, wherein the depth-setting unit is disposed on outer walls of the main unit, the control unit is used to control the operation of the air compressor, and the synchronizing connector is used to connect the connecting rod to the air compressor, so as to synchronize the back-and-forth movement of the connecting rod with the air pressure of the air compressor;
setting an underwater depth for the depth-setting unit;
putting the sampling apparatus in the radioactive reservoir of nuclear facilities or in the container of said reservoir at the underwater depth;
controlling the operation of the air compressor with the control unit and thus move the connecting rod backward to draw in the solution sample;
taking the sampling apparatus out of the radioactive reservoir or the container; and
controlling the operation of the air compressor with the control unit and thus move the connecting rod forward to extract the solution sample out.

5. The sampling method of claim 4, wherein the container unit further comprises:
a solution container;
an adjusting rod, for adjusting the draw-in or extracted-out volume of the sampled solution in the solution container; and
a ring buckle, for fixing or taking apart the solution container on or from the main unit.

6. The sampling method of claim 4, when sampling the radioactive solution in a container of the radioactive reservoir in a nuclear facility, the depth-setting unit further comprising a fixer to fix the main unit on the container and outside the entry of the container.
